(19) United States
(12) Patent Application Publication
(10) Pub. No.: US 2016/0260942 A1
(43) Pub. Date: Sep. 8, 2016

(54) BACK CARRIED BATTERY PACK HAVING A CARRYING ARRANGEMENT

(71) Applicant: Andreas Stihl AG & Co. KG, Waiblingen (DE)

(72) Inventors: Daniel Wagner, Winterbach (DE); Patrick Behringer, Ostfildern (DE); Markus Zeller, Schwaebisch Gmuend (DE); Alexander Maier, Waiblingen (DE)

(21) Appl. No.: 15/061,884

(22) Filed: Mar. 4, 2016

(30) Foreign Application Priority Data
Mar. 4, 2015 (DE) 10 2015 002 720.4

(51) Int. Cl. H01M 2/10; H01M 2/20; A45F 3/04

(52) U.S. Cl. CPC H01M 2/1005; A45F 3/04; H01M 2/20; H01M 2/1022; A45F 2003/003

(57) ABSTRACT

The invention relates to a battery pack which is worn on the back and has an arrangement of rechargeable battery cells provided with a common electrical connection for a line to an electric load (M). A carrying arrangement includes at least one back panel and at least one shoulder strap. The back panel is configured with an upper, shoulder portion and with a lower, back portion. The line is guided into the carrying arrangement through an opening in the back panel and routed from the opening in the back panel to an outer periphery of the carrying arrangement. The line is guided onward along at least one section of the outer periphery of the carrying arrangement and is secured in a releasable manner by at least one fastening element in the region of the section of the outer periphery of the carrying arrangement.

### CROSS REFERENCE TO RELATED APPLICATION

This application claims priority of German patent application no. 10 2015 002 720.4, filed Mar. 4, 2015, the entire content of which is incorporated herein by reference.

### BACKGROUND OF THE INVENTION

United States patent application publication 2013/0162055 discloses a battery pack which is worn on the back, an arrangement of rechargeable battery cells being accommodated in the battery-pack housing. The arrangement of battery cells in the battery-pack housing has a common electrical connection provided in the top region of the battery-pack housing. A line which leads to an external electric load can be connected to the electrical connection.

The battery-pack housing is carried on a user's back via a carrying arrangement made up of a back panel and at least two shoulder straps, wherein the back panel is configured with an upper, shoulder portion and with a lower, back portion. The shoulder straps have an upper end secured in the upper, shoulder portion of the back panel and a lower end secured in the region of the lower, back portion of the back panel.

The course followed by the line from the battery pack to the electric load is dependent on the work apparatus used and on the work which is to be carried out and should be such that the user's freedom of movement is neither impeded nor restricted. For this purpose, United States patent application publication 2013/0162055 proposes providing guide channels in the battery-pack housing for the purpose of guiding the line, wherein the guide channels are accessible only when the battery pack is released from the back panel of the carrying arrangement.

### SUMMARY OF THE INVENTION

It is an object of the invention to specify a straightforward line-guiding setup, from the battery pack to the electric load in the work apparatus, which the user can easily alter, and adapt to changing working conditions, even on site.

The back carried battery pack of the invention is for an exterior load. The back carried batter pack includes: a battery pack housing; an arrangement of rechargeable cells accommodated in the battery pack housing; the arrangement of rechargeable cells having a common electrical connection; a connecting line configured to connect the common electrical connection to the exterior load; the batter pack housing including a carrying arrangement having a back panel and a shoulder strap; the back panel having an upper shoulder section and a lower back section; the shoulder strap having an upper end fixed to the upper shoulder section and a lower end fixed to the lower back section; the back panel defining an opening; the connecting line being guided through the opening and into the carrying arrangement; the carrying arrangement having an outer periphery; the connecting line being routed from the opening in the back panel to the outer periphery and being further guided along a segment of the outer periphery; and, at least one fastening element configured to releasably fix the connecting line to the outer periphery in the segment of the outer periphery.

The line is guided into the carrying arrangement through an opening in the back panel, and this therefore allows a straightforward line-guiding setup in the carrying arrangement. The line is expediently routed from the opening in the back panel to an outer periphery of the carrying arrangement and is guided onward to the electric load along a section of the outer periphery of the carrying arrangement. The line here is secured in a releasable manner by a fastening element at least in the region of a section of the outer periphery of the carrying arrangement.

If the working conditions alter, release of the fastening element allows the line-guiding setup provided to be disengaged and changed to a line-guiding setup better suited to the current working environment.

The line guided into the carrying arrangement through the opening is advantageously guided to the outer periphery of the carrying arrangement between the upper ends of the shoulder straps. This results in just a short distance between the opening and the outer periphery.

The line is reliably retained by being secured on the back panel by a fastening element in the section between the opening and the outer periphery of the carrying apparatus.

So that the line does not bother the user, provision is made for the line to be guided to the outer periphery of the carrying arrangement between pads of the back panel.

The outer periphery of the carrying arrangement is formed, in the first instance, by the periphery of the back panel; it is also case that the shoulder straps form an outer periphery of the carrying arrangement. In particular, the outer periphery is also formed by those sides of the shoulder straps which are directed away from the back panel.

In order to ensure a straightforward line-guiding setup along the outer periphery of the back panel, provision is made for the back panel to be wider than the battery-pack housing, and the back panel therefore projects preferably to a slight extent beyond the side surfaces of the battery-pack housing.

Guiding the line into the carrying arrangement via the opening of the back panel makes it possible for the battery-pack housing itself to be protected against moisture and dirt in a straightforward manner by a cover. For this purpose, a cover, which accommodates the battery-pack housing, may be fastened on the back panel. It is expedient here for the cover to be open at the lower end, adjacent to the back portion of the back panel, and therefore for example a standing surface of the battery pack remains freely accessible.

The cover is expediently formed from a water-repellent, flexible material and is secured in an easily interchangeable manner on the back panel via a releasable, water-repellent closure.

### BRIEF DESCRIPTION OF THE DRAWINGS

The invention will now be described with reference to the drawings wherein:

FIG. 1 shows a perspective illustration of a battery pack with a carrying arrangement for carrying the pack on the back of a user (not illustrated),

FIG. 2 shows a perspective illustration of the carrying arrangement according to FIG. 1;

FIG. 3 shows a side view of the battery pack with carrying arrangement;

FIG. 4 shows a side view of the battery pack with carrying arrangement according to FIG. 3, the hip portion being illustrated in the carrying position and, using dashed lines, in the pivoted-in state; and,

FIG. 5 shows a side view of a battery pack set down on the ground and with the hip portion pivoted in.

### DESCRIPTION OF THE PREFERRED EMBODIMENTS OF THE INVENTION

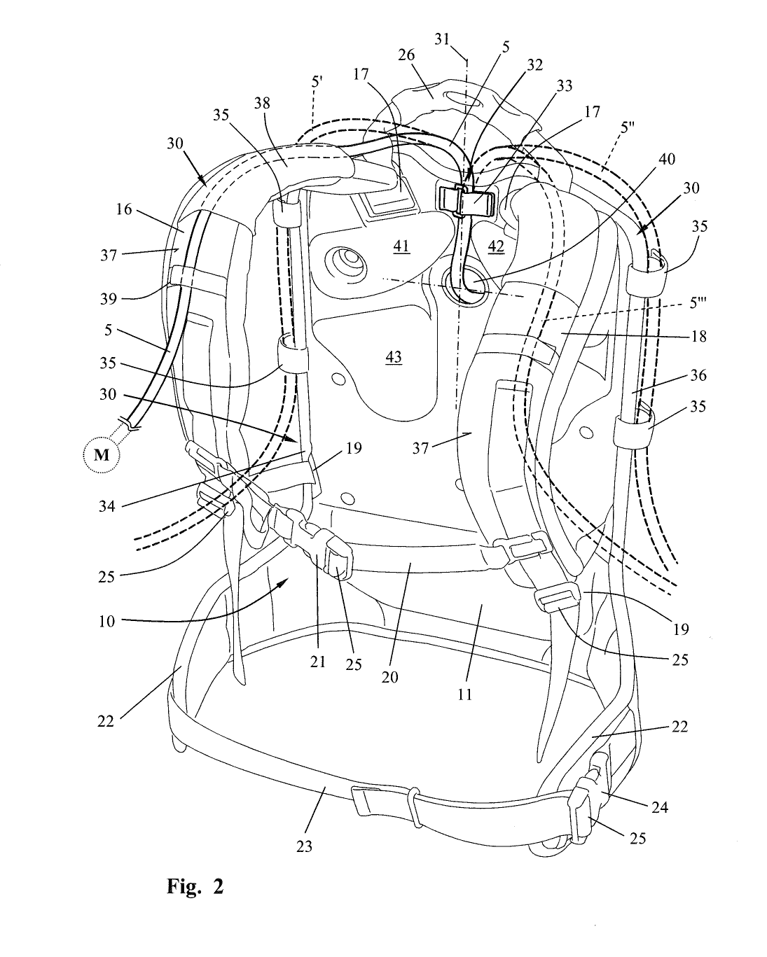

The battery pack 1 which is worn on the back, and is shown in the embodiment, has a battery housing 2. An arrangement of rechargeable battery cells 3 is provided in the battery housing 2, as indicated by dashed lines. The arrangement of battery cells 3 has, in a connection box, a common electrical connection 4, to which is connected a line 5 (FIG. 2) to an external electric load M. The line is advantageously configured in the form of a flexible line. If there is a possibility of higher loading occurring, the line may also be configured in the form of a cable. The battery pack 1 or the battery-pack housing 2 is fixed, in the embodiment, to the back panel 6 of a carrying arrangement 10; it may be expedient for the back panel 6 to be formed in one piece with the battery-pack housing 2.

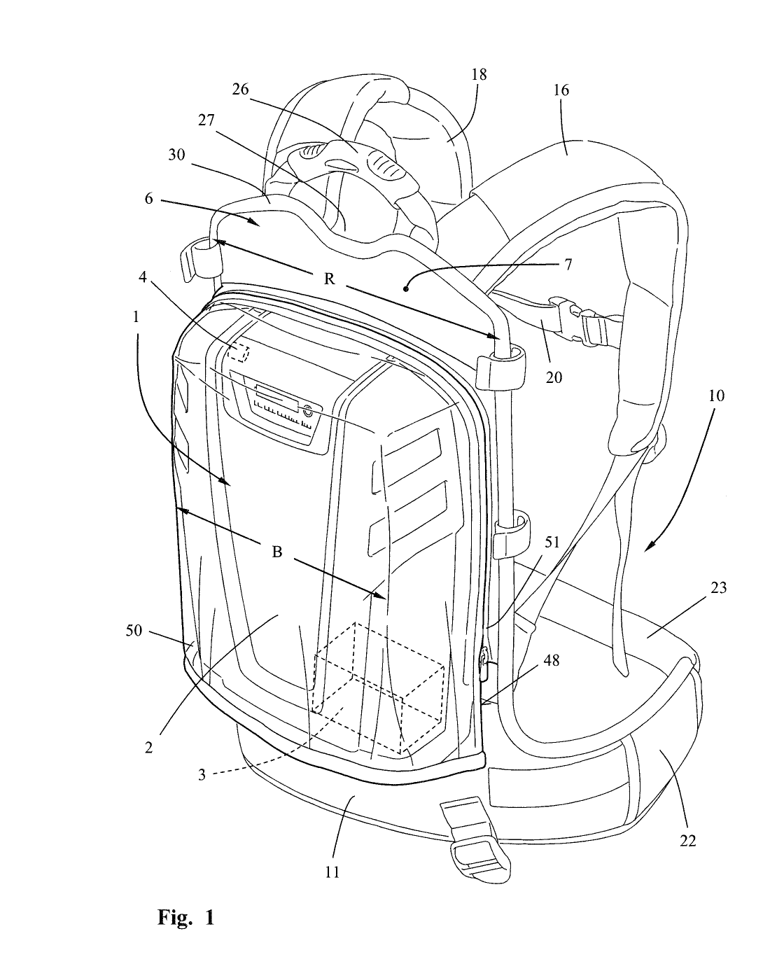

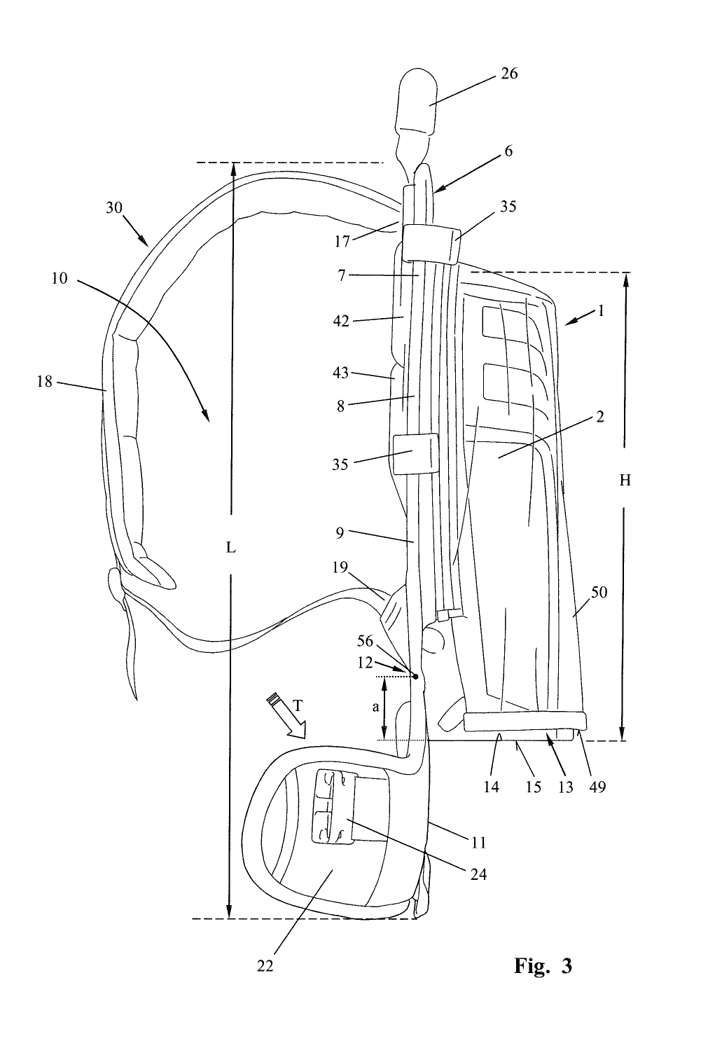

As FIG. 3 shows, the back panel 6 extends in a vertical direction from an upper, shoulder portion 7, via a central portion 8, to a lower, back portion 9. As is also illustrated in FIGS. 1 to 5, the back panel 6 in the embodiment is extended beyond the back portion 9 by way of a hip portion 11. The hip portion 11 expediently follows the back portion 9 via a textile hinge, preferably via an elastic woven-fabric portion 12, and therefore the hip portion 11 can be moved about a movement axis 56 relative to the back panel 6 or the back portion 9 thereof. The pivotable attachment of the hip portion 11 to the back portion 9 may also be achieved in some other way, for example, by a joint or the like.

As FIG. 3 shows, the approximately cuboidal battery-pack housing 2 has a height H, which extends from the shoulder portion 7, via the central portion 8 and the back portion 9, into the hip portion 11. FIGS. 1 and 3 show that the shoulder portion 7 projects upward beyond the battery-pack housing 2; correspondingly, the hip portion 11 projects beyond the lower end 13 of the battery-pack housing 2.

The lower end 13 of the battery-pack housing 2 forms the base 14 of the battery-pack housing. The lower end 13 may be configured such that the battery-pack housing 2 forms an outer, preferably planar standing surface 15. As an alternative, it may be advantageous to fit feet, of which the supporting surfaces define the standing surface 15. As FIG. 3 shows, the movement axis 56 is located in the region of the standing surface 15, expediently at a distance (a) above the standing surface 15 of the battery-pack housing 2. The movement axis 56 is spaced apart from the base 14 by a greater distance than the standing surface 15. The textile hinge or the woven-fabric portion 12 is expediently located at a distance (a) above the standing surface 15.

The width R (FIG. 1) of the back panel 6 is slightly greater than the width B of the battery-pack housing 2, preferably 1 to 5 cm greater than the width B of the system module 1; the height L (FIG. 3) of the back panel 6 is greater than the height H of the battery-pack housing 2; the height L of the back panel 6 is approximately 30% to 70% longer than the height H of the battery-pack housing 2.

The carrying arrangement 10 for the battery pack 1, which is worn on the back, includes shoulder straps (16, 18), which have their upper ends 17 secured in the region of the upper, shoulder portion 7 of the back panel 6. The lower ends 19 of the shoulder straps (16, 18) are fastened in the region of the lower, back portion 9 of the back panel 6.

The shoulder straps (16, 18) can be connected to one another via a chest strap 20; the chest strap 20 runs transversely from the center of the one shoulder strap 16 to the other shoulder strap 18 and can be opened and closed via a lock 21.

The hip portion 11 of the back panel 6 has two lateral hip flaps 22, which can be closed at the level of a user's hips via a connecting strap 23 and a lock 24.

The shoulder straps (16, 18), the chest strap 20 and the connecting strap 23 also have adjusting arrangement 25 for adapting the length of the straps. In order for the battery pack 1, together with the carrying arrangement 10, to be easily carried by hand, a handle loop 26 is secured in the upper region of the shoulder portion 7. In the region of the handle loop 26, the upper outer periphery 30 of the back panel 6 has a central concavity 27.

The invention makes provision for the in particular flexible line 5, connected to the connection 4, to be guided through an opening 40 in the back panel 6. The opening 40 is in the form of a circular opening in FIG. 2; other shapes of the opening 40 may be expedient.

The opening 40 is advantageously located on the longitudinal center axis 31 of the back panel 6. The opening 40 is expediently located in the transition region between the shoulder portion 7 and the central portion 8. As FIG. 1 shows, the opening 40 is completely covered by the battery-pack housing 2.

The line 5 embodied in the form of a flexible line is guided into the carrying arrangement 10 through the opening 40, as FIG. 2 shows. From the opening 40, the line 5 is expediently routed to an outer periphery 30 of the carrying arrangement 10. In the embodiment according to FIG. 2, the line 5 runs along the longitudinal center axis 31 to the upper outer periphery 30 of the shoulder portion 7. The line 5 here is located between the upper ends 17 of the shoulder straps (16, 18). In particular, the line 5 is secured on the back panel 6 by a fastening element 32 between the opening 40 and the outer periphery 30 of the carrying arrangement 10. The fastening element 32 is preferably a loop 33, which is easy to close and easy to open by way of a Velcro-type closure.

The line 5, en route to a schematically illustrated electric load M, is guided onwards along at least one section of the outer periphery 30 of the carrying arrangement 10, in the embodiment along a section of the upper outer periphery 30 of the shoulder portion 7. At the level of the shoulder strap 16, the line 5 is guided onward along the outer side 37 of the strap, as is shown in solid lines in FIG. 2 on the right-hand shoulder strap 16. The outer side 37 of the strap forms a further outer periphery 30 of the carrying arrangement 10. The outer side 37 of the strap is that longitudinal side of the shoulder strap 16 which is directed away from the back panel 6. FIG. 2 shows that the line 5 is guided through a sleeve 38, which is retained on the shoulder strap 16. It may be expedient for the line 5 to be secured on the shoulder strap 16 by a fastener 39 as an alternative, or in addition, to the sleeve 38. The fastener 39 is expediently a loop with a Velcro-type closure, which is sewn on the shoulder strap 16.

In a first alternative, the line 5′ can be guided along the vertical edge 34 of the back panel 6, rather than via the shoulder strap 16, wherein the vertical edge 34 forms part of the outer periphery of the carrying arrangement 10. The line 5′ is guided along the outer periphery 30 of the carrying arrangement 10 via loop-like fastening elements 35.

Correspondingly, in a third alternative, the line 5″ is guided along the opposite outer periphery 30, wherein this outer periphery 30 is formed by the other vertical edge 36 of the back panel 6.

A further outer periphery 30 of the carrying arrangement is also formed by the side 37 of the further shoulder strap 18, the side being directed away from the back panel 6 and being capable of having the line or the cable guided on it, along the left-hand shoulder strap 18, as an alternative. In the further alternative shown, starting from the outer periphery 30 of the shoulder portion 7, the line 5″′ is guided to the load, along the shoulder strap 18, on the side 37 of the strap, which is directed away from the back panel 6. It is possible here for the line 5″′ to be retained on the side 37 of the strap by a sleeve 38 or by easy-to-close fastener 39, preferably via strips of a hook and loop-type closure which are sewn to the shoulder strap (16, 18).

For it to be possible for the battery pack 1 to be worn comfortably on the user's back, pads (41, 42, 43) are provided on the back panel 6, as indicated in FIG. 2. The line 5 is expediently routed to the outer periphery 30 of the carrying arrangement 10 between the pads 41 and 42. The height of the pads (41, 42, 43) here is selected such that the line 5, configured in the form of a flexible cable, is guided in a set-back state between the pads 41 and 42. It is thus not possible for the line 5 to rest on the user's back.

As FIGS. 1 and 3 show, the battery pack 1, which is fastened on the back panel 6, has a cover 50. The cover 50 spans the battery-pack housing 2 essentially over the entire height H; it is only the end 49 of the cover 50, the end being adjacent to the back portion 9, which is open.

The cover 50 is made of a water-repellent, flexible material and is secured on the back panel 6 by way of a periphery 48. The embodiment shows a releasable, water-repellent closure 51 between the cover 50 and the back panel 6; this closure is expediently configured in the form of a zip, in particular of a water-tight zip.

Since the line 5 is guided inward into the carrying arrangement 10 through the opening 40 in the back panel, it is possible for the cover 50 to be a straightforward configuration. The line 5 does not pose a problem in respect of covering the battery housing 2 in a water-protected manner.

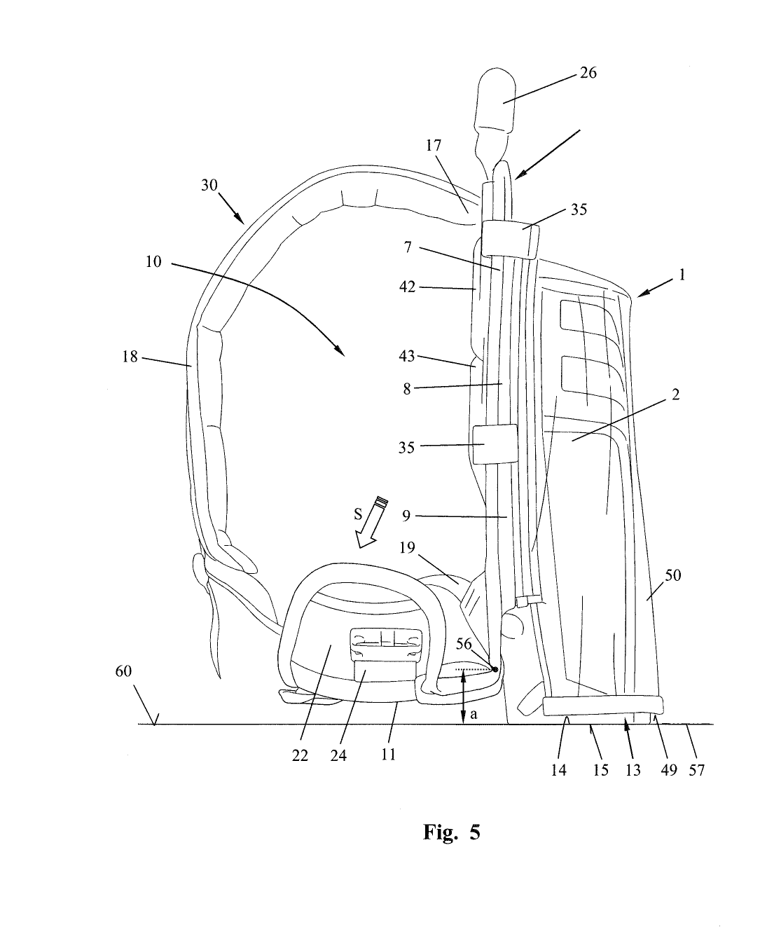

As explained above, the battery-pack housing 2 has a base 14 with a standing surface 15, by which the battery-pack housing can be set down on a ground surface 60 (FIG. 5). The standing surface 15 is configured such that the battery pack 1, together with the carrying arrangement 10, stands reliably upright on the ground.

The back panel 6, which is extended beyond the back portion 9 by way of a hip portion 11, is configured such that the hip portion 11, together with its side flaps 22, can be pivoted in arrow direction 55 about the movement axis 56. The woven-fabric portion 12 here forms a textile hinge and the movement axis 56, about which the hip portion 11 can be pivoted relative to the back portion 9.

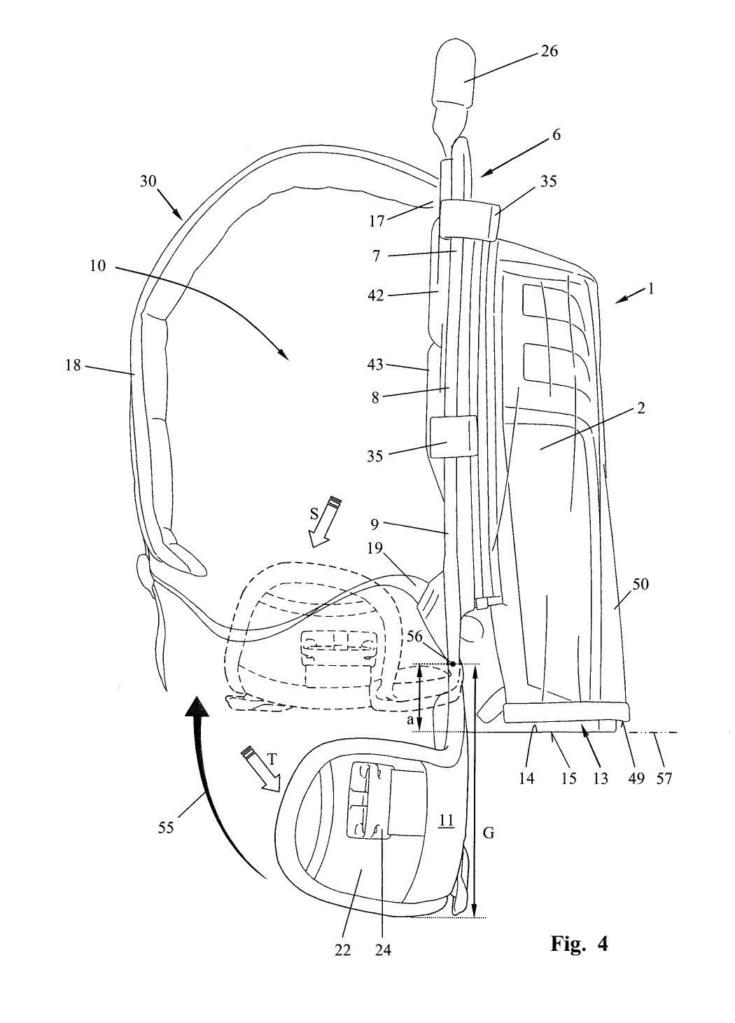

As shown in FIGS. 3 and 4, the movement axis 56 is located at a distance (a) above the standing surface 15. As viewed from the rear of the battery-pack housing 2, the movement axis 56 is covered over by the battery-pack housing 2.

The movement axis 56 runs parallel to the plane 57 of the standing surface 15. It is sufficient for the movement axis 56 to extend approximately level with the standing surface 15 of the battery-pack housing 2.

From the carrying position T according to FIG. 3, the hip portion 11 can be pivoted in arrow direction 55, about the pivot axis 56, into the pivoted position S; counter to the arrow direction 55, the hip portion 11 is supported, in the carrying position T, against the battery-pack housing 2. Stable support is achieved if the distance (a) selected is sufficiently large, in the example embodiment shown, the distance (a) is approximately 10% to 30% of the height G of the hip portion 11.

In arrow direction 55, the hip portion 11 can be moved by approximately 90°, beyond the plane 57 of the standing surface 15, into the pivoted position S; in this pivoted position S—as a result of the distance (a) between the movement axis 56 and the standing surface 15—the hip portion 11 is located above the plane 57 of the standing surface 15. This makes it possible -as FIG. 5 shows - for the battery pack 1, together with the carrying arrangement 10, to be set down reliably on the ground 60 without the hip portion 11 getting in the way. The distance (a) between the movement axis 56 and the standing surface 15 also ensures that the hip portion 11, which can be pivoted into the pivoted position S, is spaced apart, in the pivoted position S, from the ground 60. This ensures that the battery pack 1, together with the carrying arrangement 10, stands reliably upright on the ground 60.

It is understood that the foregoing description is that of the preferred embodiments of the invention and that various changes and modifications may be made thereto without departing from the spirit and scope of the invention as defined in the appended claims.

What is claimed is:

1. A back carried battery pack for an exterior load, the back carried batter pack comprising:
a battery pack housing;
an arrangement of rechargeable cells accommodated in said battery pack housing;
said arrangement of rechargeable cells having a common electrical connection;
a connecting line configured to connect said common electrical connection to the exterior load;
said batter pack housing including a carrying arrangement having a back panel and a shoulder strap;
said back panel having an upper shoulder section and a lower back section;
said shoulder strap having an upper end fixed to said upper shoulder section and a lower end fixed to said lower back section;
said back panel defining an opening;
said connecting line being guided through said opening and into said carrying arrangement;
said carrying arrangement having an outer periphery;
said connecting line being routed from said opening in said back panel to said outer periphery and being further guided along a segment of said outer periphery; and,
at least one fastening element configured to releasably fix said connecting line to said outer periphery in said segment of said outer periphery.

2. The battery pack of claim 1, wherein said shoulder strap is a first shoulder strap, the battery pack further comprising:
a second shoulder strap having an upper end; and,
said connecting line is guided between said upper end of said first shoulder strap and said upper end of said second shoulder strap.

3. The battery pack of claim 1, wherein said fastening element is a first element, the battery pack further comprising a second fastening element configured to fix said connecting line to said back panel between said opening and said outer periphery.

4. The battery pack of claim 1, wherein:
said back panel has a first pad and a second pad; and,
said connecting line is guided between said first pad and said second pad to said outer periphery.

5. The battery pack of claim 1, wherein said back panel has an outer panel periphery and said outer periphery of said carrying arrangement is formed by said outer panel periphery.

6. The battery pack of claim 1, wherein:
said shoulder strap has a first side facing away from said back panel; and,
said outer periphery of said carrying arrangement is formed by said first side of said shoulder strap.

7. The battery pack of claim 1, wherein said battery pack housing defines side edges; and, said back panel extends beyond said side edges.

8. The battery pack of claim 1, wherein said fastening element is configured as a loop; and, said loop is configured to be openable and closeable via a hook-and-loop fastener.

9. The battery pack of claim 1 further comprising a cover fixed on said back panel and configured to accommodate said battery pack housing.

10. The battery pack of claim 9, wherein said cover has a lower end disposed adjacent to said lower back section; and, said cover is open at said lower end.

11. The battery pack of claim 9, wherein said cover is made of a water-repellent, flexible material.

12. The battery pack of claim 9 further comprising a releasable, water-repellent closure configured to fix said cover to said back panel.
